(19) United States
(12) Patent Application Publication
(10) Pub. No.: US 2018/0065341 A1
(43) Pub. Date: Mar. 8, 2018

(54) Thermoplastic Laminate Sheet and Method of Manufacturing the Sheet

(71) Applicant: Incussus, LLC, Middletown, DE (US)

(72) Inventors: Giuseppe Cerizza, Villa Guardia (co) (IT); Hugo Enrique Conde Balza, Weston, FL (US)

(73) Assignee: Incussus, LLC, Middletown, DE (US)

(21) Appl. No.: 15/800,595

(22) Filed: Nov. 1, 2017

Related U.S. Application Data
(63) Continuation of application No. PCT/IB2016/053050, filed on May 25, 2016.

(30) Foreign Application Priority Data
May 26, 2015 (IT) 102015000018001
May 18, 2016 (IT) 102016000051211

(51) Int. Cl. B32B 21/08; B32B 37/06; B32B 37/10; B32B 37/15; B32B 38/00; B32B 38/06; B32B 27/08

(52) U.S. Cl. CPC B32B 21/08; B32B 37/06; B32B 37/10; B32B 2307/412; B32B 38/0004; B32B 38/06; B32B 27/08; B32B 37/153

(57) ABSTRACT

A method for manufacturing a flat laminate sheet comprises coupling first and second thermoplastic layers to one another without glue by superficially heating coupling surfaces of the two layers and pressing the heated layers onto one another without glue to form a first combined thermoplastic multilayer free from glue, the layers each being a film free of plasticizers and comprising PVC, PET, PETG, PP, and/or PE, and coupling a third thermoplastic layer of a film comprising PVC, PET, PETG, PP, and/or PE to the first combined thermoplastic multilayer by superficially heating coupling surfaces of the third layer and the first combined thermoplastic multilayer and pressing the heated third layer and the first combined thermoplastic multilayer onto one another without glue to form a multilayer laminate sheet free from glue, being planar, flat, and rigid, and having a thickness between approximately 0.75 to 4 mm.

### CROSS-REFERENCE TO RELATED APPLICATIONS

This is a continuing application, under 35 U.S.C. §120, of copending international application No. PCT/IB2016/053050, filed May 25, 2016, which designated the United States and was published in English; this application also claims the priority, under 35 U.S.C. §19, of Italian Patent Application No. 102015000018001, filed on May 26, 2015, and Italian Patent Application No. 102016000051211, filed on May 18, 2016, the prior applications are herewith incorporated by reference in their entireties.

### STATEMENT REGARDING FEDERALLY SPONSORED RESEARCH OR DEVELOPMENT

Not Applicable

### FIELD OF THE INVENTION

The present invention relates to a thermoplastic laminate sheet comprising a multiplicity of thermoplastic layers and a method for manufacturing the sheet.

### BACKGROUND OF THE INVENTION

Surfaces of pieces of furniture or structures made of wood or particleboard materials, such as, for example, the so-called MDF (Medium Density Fiberboard), are made more valuable using decorative laminated products, the so-called HPLs (High Pressure Laminates), or thermoplastic films.

The decorative laminated products are mainly used as materials to be applied by pressing to the surfaces of the pieces of furniture or of structures made of wood or particleboard. A HPL sheet comprises a kraft paper base impregnated with phenolic resins that have thermosetting function, a decorative layer of printed or solid color paper, and an overlay of thermosetting melamine resin having finishing function. Such HPL decorative laminate products are applied to the sheet-shaped surfaces, e.g., following an American standard ANSI/NEMA LD 3-2005 or a European standard EN438. The thickness of the HPL sheet is from 0.7 mm to 2 mm. However, the HPL sheets have the technical disadvantage of being subject to deformations because of the various layers glued onto one another, and have edges that bend upwards in the corners of the sheet, making the application to such surfaces difficult. Furthermore, the HPL sheets have the disadvantage of cracking on the edges of the pieces of furniture because of the stress forces to which the various layers of the HPL sheet are subjected in a differentiated manner. The HPL sheets have the disadvantage of having edges that lift unless insufficient glue is used to withstand the differential stresses between the various layers of the HPL sheet. Furthermore, an additional technical disadvantage of the HPL sheets is that, once they are glued to a surface, there is an apparent lack of color uniformity on the entire thickness; indeed the passage between two HPL sheets is apparent because a color difference between a lower part of the kraft paper and the overlay is clearly visible on the edges of the HPL sheets. The use of HPL sheets is disadvantageous because the sheet must be applied by a layer of glue, thus consuming a lot of glue to achieve an optimal application to the surface. American standard ANSI/NEMA LD 3-2005 shows the mechanical properties of HPL decorative laminate products concerning resistance to stress and to mechanical shocks, flatness properties of the sheets, deformation features of the sheet, and features of cracking of the sheet on the edges once it is glued to surfaces. The HPL sheets have a resistance index of 55 inches for ball impact resistance and of 22 inches for dart impact resistance as shown in Table 2-1 of American standard ANSI/NEMA LD 3-2005. The HPL sheet is disadvantageously subject to humidity-related problems, indeed the HPL sheet loses it flatness in the presence of humid environments because the HPL sheet comprises paper layers that absorb the humidity and deform the HPL sheet, creating problems during the gluing of the HPL sheet to the surface. With reference to table 2.4 of the American standard ANSI/NEMA LD 3-2005, a flatness test is performed, which test measures and records the thickness of the sheet in all corners of the sheet and at mid-point of each side of the sheet, according to the technical procedures explained in paragraph 3.1.5 of the American standard ANSI/NEMA LS 3-2005. The result of this flatness test is +/−120 mm for the single-face HPL sheet less than 2 mm thick, while for the single-face HPL sheet thicker than 2 mm the result of the flatness test is +/−50 mm.

The thermoplastic films are instead glued over surfaces of furniture or structures made of wood or particleboard materials. The thermoplastic films are very thin, i.e., from 0.25 to 0.7 mm at most. The thickness of the thermoplastic films that are applied in a membrane press to the surfaces of furniture doors made of MDF is often less than 0.5 mm for technical reasons related to membrane pressing. Exceptionally, in some cases, the thickness of the thermoplastic films may reach up to 0.7 mm. Instead, the thickness of thermoplastic films that are applied flat to panel surfaces made of MDF or particleboard is from 0.12 to 0.3 mm. Disadvantageously, the thickness of the thermoplastic films from 0.12 to 0.3 mm must be applied to such surfaces by vacuum presses or membrane presses. Disadvantageously, the thermoplastic films do not maintain their flatness because they are too thin and they are less than 0.7 mm thick, and, when produced, they are wound or rolled into coils or cylinders. Also disadvantageously, lamination machines may apply such thermoplastic films of thickness from 0.12 to 0.3 mm only if wound on coils (i.e., rolled on cylinders) because of the low rigidity of such thermoplastic films, which do not allow them to be formed in the shape of a sheet. A further disadvantage of the thermoplastic films according to the prior art is due to the fact that they have neither the mechanical properties nor the technical properties of resistance to stress and to shocks of the HPL sheets. Thermoplastic films of the type described above are, for example, those described in International Publication No. WO/2010/034877-A1 to Kiljunen et al. (corresponding to International Application No. PCT/FI2009/050663 filing on Aug. 17, 2009) and U.S. Pat. No. 6,171,681 B1 to Mascarenhas et al. Further publications include U.S. Pat. No. 3,976,528 to James, which describes thin films used as overlay on kraft paper, and United States Patent Publication No. 2012/0028049 A1 to Prejean et al., which describes thin films used as interlayer between two different layers.

In order to acquire some mechanical properties of the HPL sheets, i.e., of the laminates, the background art describe sheets comprising thermoplastic film multilayers disadvantageously assembled with layers of different materials, e.g., as described in U.S. Pat. No. 6,333,094 B1 to Schneider et al., 6,159,583 to Calkins, and U.S. Pat. No. 7,064,092 B2 to Hutchison et al., and in United States Patent Publication No. 2003/0036323 A1 to Aliabadi. Such layers of different materials allow for the increase in the flatness of the sheet comprising thermoplastic film multilayers but disadvantageously increase the use of glue between one layer and the other, disadvantageously creating problems of deformation and of gluing between the various layers and the surface and, furthermore, cannot achieve the mechanical shock resistance of the HPL sheets.

There are no thermoplastic films thicker than 0.7 mm in the background art to be applied to structures made of wood or particleboard material, such as furniture, because there are technical problems in manufacturing them, which problems have remained unsolved until now. Such problems are caused by the delamination of the film during the manufacturing process, which couples the layers of thermoplastic film on top of one another. These technical problems cause deformations of thermoplastic film layers, delamination, formation of folds, and exaggerated stretching of the thermoplastic film, which creates thickness differences so as to cause loss of uniformity of the thermoplastic material film thickness and over-density in the layers, which causes loss of uniformity of thickness of the thermoplastic film layer, thus disadvantageously limiting mechanical resistance and flatness.

Thermoplastic layers joined to layers of different material that may be thicker than 0.7 mm are known in the background art, such as the 1- or 2-mm thick layers described in International Publication No. WO/2001/00406-A1 to Kang et al. (corresponding to International Application No. PCT/KR2000/000664, filed Jun. 26, 2000), which are however used for floors and are applied horizontally and not to furniture or structures made of wood or particleboard materials with substantially vertical walls. Such thick layers cannot be used for vertical walls because the layers of different materials glued to one another deform by slipping, creating differences of thickness and loss of uniformity, thus disadvantageously limiting mechanical resistance and flatness. Disadvantageously, glue is extensively used in such products.

The other thermoplastic layers for covering floors are approximately 20 mil thick, i.e., approximately 0.5 mm, and are described in International Publication No. WO/2015/094665 to Anspach et al. (corresponding to International Application No. PCT/US2014/068332 field Dec. 3, 2014).

U.S. Patent Publication No. 2004-0188006 A1 to Montagna et al. describes a method for manufacturing thermoplastic films that comprises a simultaneous coupling between two thermoplastic layers and at most three thermoplastic layers by comb rollers and by compression, the two thermoplastic materials are glued to each other by glues that are sprayed onto a contact surface between the two thermoplastic layers before they are coupled. A multilayer comprising two thermoplastic layers glued to each other and divided into sheets by cutting, e.g., by guillotine cutting, is obtained at the end of the coupling process. Disadvantageously, glue is extensively used to glue the two thermoplastic layers to each other. Furthermore, the multilayer formed by two or three thermoplastic layers is not shock-resistant and does not have technical features comparable to those obtained with HPL sheets. The sheets obtained with the method described in U.S. Patent Publication No. 2004-0188006 A1 cannot be as thick as the HPL sheets because, when three thermoplastic layers are coupled, they must pass simultaneously under a single roller and must be glued along all the gluing surfaces to one another. Performing a single coupling of more than two thermoplastic layers at the same time permits avoiding exaggerated stretching of the thermoplastic film, avoiding the creation of thickness differences so as to cause loss of uniformity of the thermoplastic material film thickness and over-density in the layers, which cause loss of uniformity of thickness of the thermoplastic film layer, thus however disadvantageously limiting mechanical resistance and flatness. However, high thickness cannot be obtained with such single simultaneous coupling, unless one is willing to accept deformations of the thermoplastic film layers and delamination, because the single layers need to be heated to excessively high temperatures to such an extent that causes deformation, or, alternatively, as described in U.S. Patent Publication No. 2004-0188006 A1, such layers must be glued to one another with an extremely high and excessive use of glue. The use of glue between one layer and the other of the thermoplastic layers does not solve the problems of lifting the sheets at the edges, disadvantageously creating problems of gluing on the surfaces and problems related to sheet deformations and cracking on the edges of the surfaces once the sheet is further glued to the surfaces. The use of glues for gluing the multiple thermoplastic layers is disadvantageous because shock resistance comparable to that of HPL sheets cannot be obtained.

Methods of manufacturing thermoplastic laminates are described, for example, in U.S. Pat. No. 5,019,203 to Singer and in German Published, Non-Prosecuted Patent Application DE 3004321 A1 to Comerio.

Embossing methods are described for example in U.S. Pat. No. 3,208,898 to Chavannes et al.

### SUMMARY OF THE INVENTION

The systems, apparatuses, and methods described provide a piece of furniture or a structure made of wood or particleboard that mounts a thermoplastic laminate to at least one surface, a thermoplastic laminate sheet, and a method for manufacturing the sheet that overcome the hereinafore-mentioned disadvantages of the heretofore-known devices and methods of this general type, the thermoplastic laminate having the mechanical properties of resistance to stress and to shocks either comparable to or greater than those of the HPL decorative laminated product sheets, having flatness properties comparable to those of HPL sheets, being applied to the surfaces of pieces of furniture or of structures made of wood or particleboard materials with use of less glue, being not subject to deformation and not having edges that bend upwards in the corners, being easy to be applied to such surface, not cracking on the edges of the surfaces, not having humidity-related problems or problems of application to such surfaces in humid environments, and having color uniformity on any entire surface.

With the foregoing and other objects in view, there is provided, a method for manufacturing a flat laminate sheet comprises coupling first and second thermoplastic layers to one another without glue by superficially heating coupling surfaces of the two thermoplastic layers and pressing the heated first and second thermoplastic layers onto one another without glue to form a first combined thermoplastic multilayer free from glue, the first and second thermoplastic layers each being a film free of plasticizers and comprising at least one of PVC, PET, PETG, PP, and PE and coupling a third thermoplastic layer of a film comprising at least one of PVC, PET, PETG, PP, and PE to the first combined thermoplastic multilayer by superficially heating coupling surfaces of the third thermoplastic layer and the first combined thermoplastic multilayer and pressing the heated third thermoplastic layer and the first combined thermoplastic multilayer onto one another without glue to form a multilayer laminate sheet free from glue, being planar, flat, and rigid, and having a thickness from between approximately 0.75 mm to approximately 4 mm.

In accordance with another mode, one of the first, second, or third thermoplastic layers is a superficial thermoplastic layer.

In accordance with a further mode, the superficial thermoplastic layer is a transparent, crystal superficial thermoplastic layer treated with a finishing paint and having a plasticization between approximately 10 phr to approximately 30 phr.

In accordance with an added mode, the crystal superficial thermoplastic layer is filled with mineral filers comprising at least one of TiO₂, calcium carbonate, silica, and talc.

In accordance with an additional mode, the superficial thermoplastic layer is transparent and has a thickness of approximately 100 micrometers, each of the ones of the first, second, and third thermoplastic layers has a thickness of approximately 350 micrometers, and the multilayer laminate sheet has a thickness of approximately 800 micrometers.

In accordance with yet a further mode, each of the first, second, and third thermoplastic layers are manufactured by calendering and extruding.

In accordance with yet an added mode, the multi-layer laminate is applied by pressing or gluing to a surface of one of a piece of furniture, a wood structures, and particleboard.

In accordance with yet an additional mode, before coupling the third thermoplastic layer to the first combined thermoplastic multilayer, coupling a fourth thermoplastic layer to the third thermoplastic layer without glue by superficially heating coupling surfaces of the third and fourth thermoplastic layers and pressing the heated third and fourth thermoplastic layers onto one another without glue to form a second combined thermoplastic multilayer free from glue, the fourth thermoplastic layer being a film free of plasticizers and comprising at least one of PVC, PET, PETG, PP, and PE, coupling fifth and sixth thermoplastic layers to one another without glue by superficially heating coupling surfaces of the fifth and sixth thermoplastic layers and pressing the heated fifth and sixth thermoplastic layers onto one another without glue to form a third combined thermoplastic multilayer free from glue, the fifth and sixth thermoplastic layers each being a film free of plasticizers and comprising at least one of PVC, PET, PETG, PP, and PE, and coupling the second combined thermoplastic multilayer and the third combined thermoplastic multilayer to one another without glue by superficially heating coupling surfaces of the second and third combined thermoplastic multilayers and pressing the heated second and third combined thermoplastic multilayers onto one another without glue to form a fourth combined thermoplastic multilayer free from glue; and coupling the first combined thermoplastic multilayer and the fourth combined thermoplastic multilayer to one another without glue by superficially heating coupling surfaces of the second and fourth combined thermoplastic multilayers and pressing the heated second and fourth combined thermoplastic multilayers onto one another without glue to form the multilayer laminate sheet.

In accordance with again another mode, an upper layer of the first combined thermoplastic multilayer is a transparent superficial layer approximately 100 micrometers thick, each of the second, third, fourth, fifth, and sixth thermoplastic layers is approximately 350 micrometers thick, and the multilayer laminate sheet is approximately 1850 micrometers thick.

In accordance with again a further mode, before coupling the third thermoplastic layer to the first combined thermoplastic multilayer, coupling a fourth thermoplastic layer to the third thermoplastic layer without glue by superficially heating coupling surfaces of the third and fourth thermoplastic layers and pressing the heated third and fourth thermoplastic layers onto one another without glue to form a second combined thermoplastic multilayer free from glue, the fourth thermoplastic layer being a film free of plasticizers and comprising at least one of PVC, PET, PETG, PP, and PE, coupling fifth and sixth thermoplastic layers to one another without glue by superficially heating coupling surfaces of the fifth and sixth thermoplastic layers and pressing the heated fifth and sixth thermoplastic layers onto one another without glue to form a third combined thermoplastic multilayer free from glue, the fifth and sixth thermoplastic layers each being a film free of plasticizers and comprising at least one of PVC, PET, PETG, PP, and PE, coupling seventh and eighth thermoplastic layers to one another without glue by superficially heating coupling surfaces of the seventh and eighth thermoplastic layers and pressing the heated seventh and eighth thermoplastic layers onto one another without glue to form a fourth combined thermoplastic multilayer free from glue, the seventh and eighth thermoplastic layers each being a film free of plasticizers and comprising at least one of PVC, PET, PETG, PP, and PE, coupling the second combined thermoplastic multilayer and the third combined thermoplastic multilayer to one another without glue by superficially heating coupling surfaces of the second and third combined thermoplastic multilayers and pressing the heated second and third combined thermoplastic multilayers onto one another without glue to form a fifth combined thermoplastic multilayer free from glue, and coupling the fourth combined thermoplastic multilayer and the fifth combined thermoplastic multilayer to one another without glue by superficially heating coupling surfaces of the fourth and fifth combined thermoplastic multilayers and pressing the heated fourth and fifth combined thermoplastic multilayers onto one another without glue to form a sixth combined thermoplastic multilayer free from glue; and coupling the first combined thermoplastic multilayer and the sixth combined thermoplastic multilayer to one another without glue by superficially heating coupling surfaces of the first and sixth combined thermoplastic multilayers and pressing the heated first and sixth combined thermoplastic multilayers onto one another without glue to form the multilayer laminate sheet.

In accordance with again an added mode, an upper layer of the first combined thermoplastic multilayer is a transparent superficial layer approximately 100 micrometers thick, each of the second, third, fourth, fifth, sixth, seventh, and eighth thermoplastic layers is approximately 350 micrometers thick, and the multilayer laminate sheet is approximately 2550 micrometers thick.

In accordance with again an additional mode, the multilayer laminate sheet has mechanical shock resistance properties comprising approximately 60 inches for ball impact resistance and approximately 25 to approximately 28 inches for dart impact resistance.

In accordance with still another mode, the multilayer laminate sheet has flatness properties comprising a flatness test result of +/−3 mm for a sheet having a thickness of 0.8 mm thick +/−0.05 mm.

In accordance with still a further mode, the multilayer laminate sheet has a dimensional stability lower than 0.2% both in a direction of a sheet-manufacturing machine and in a crosswise direction.

In accordance with still an added mode, the multilayer laminate sheet has a surface resistance at greater than approximately 1500 cycles for printed sheets and greater than approximately 4000 cycles for sheets of uniform color.

In accordance with still an additional mode, the multilayer laminate sheet has a post-forming radius at ambient or room temperature of 8 mm.

In accordance with another mode, a machine coupling cycle is carried out by coupling the first and second thermoplastic layers with a machine having the first thermoplastic layer on a first cylinder as a first layer and the second thermoplastic layer on a second cylinder as a second layer, tautly feeding the first and second layers onto respective sets of first and second comb rollers of the machine, at least one roller of each of the sets of first and second comb rollers heated to a respective comb roller temperature by a fluid that heats the respective first and second layers as the first and second layers are fed therethrough, tautly feeding the first and second layers from the comb rollers to coupling rollers downstream of the comb rollers, the coupling rollers pressing together the first and second layers with pressure to form the first combined thermoplastic multilayer, at least one of the coupling rollers heated to a coupling temperature by a fluid that heats the first combined thermoplastic multilayer as the first combined thermoplastic multilayer is fed therethrough, heating the first combined thermoplastic multilayer adjacent the coupling rollers with a heater to promote coupling of the first and second layers to form the first combined thermoplastic multilayer, and tautly feeding the first combined thermoplastic multilayer from the coupling rollers to at least one downstream set of cooling rollers, at least one of the cooling rollers cooled to a cooling temperature by a fluid that cools the first combined thermoplastic multilayer as the first combined thermoplastic multilayer is fed therethrough.

In accordance with a further mode, restarting the first combined thermoplastic multilayer as either the first layer or the second layer for further combined coupling with another combined multilayer previously formed by a previous machine coupling cycle after the first combined thermoplastic multilayer has cooled.

In accordance with an added mode, the first combined thermoplastic multilayer is supported downstream of the cooling rollers on a flat and planar surface and the first combined thermoplastic multilayer is cut into flat and planar sheets with a cutter disposed adjacent the cooling rollers.

In accordance with a concomitant mode, the multilayer laminate sheet has an outer surface and which further comprises embossing the outer surface to provide a pattern on the outer surface.

Although the systems, apparatuses, and methods are illustrated and described herein as embodied in a piece of furniture or a structure made of wood or particleboard that mounts a thermoplastic laminate to at least one surface or a thermoplastic laminate sheet and a method for manufacturing the sheet, it is, nevertheless, not intended to be limited to the details shown because various modifications and structural changes may be made therein without departing from the spirit of the invention and within the scope and range of equivalents of the claims. Additionally, well-known elements of exemplary embodiments will not be described in detail or will be omitted so as not to obscure the relevant details of the systems, apparatuses, and methods.

Additional advantages and other features characteristic of the systems, apparatuses, and methods will be set forth in the detailed description that follows and may be apparent from the detailed description or may be learned by practice of exemplary embodiments. Still other advantages of the systems, apparatuses, and methods may be realized by any of the instrumentalities, methods, or combinations particularly pointed out in the claims.

Other features that are considered as characteristic for the systems, apparatuses, and methods are set forth in the appended claims. As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one of ordinary skill in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the systems, apparatuses, and methods of the invention that are regarded as novel, it is believed that the systems, apparatuses, and methods will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the systems, apparatuses, and methods. Advantages of embodiments of the systems, apparatuses, and methods will be apparent from the following detailed description of the exemplary embodiments thereof, which description should be considered in conjunction with the accompanying drawings in which:

These and other features of the present invention will become further apparent from the following detailed description of practical embodiments thereof shown by way of non-limitative example in the accompanying drawings, in which:

FIG. 1 shows a fragmentary, top plan view of a sheet of thermoplastic laminate according to a first exemplary embodiment;

FIG. 2 is an enlarged, fragmentary, cross-sectional view of a cross-section A of the sheet of FIG. 1 along section line II-II;

FIG. 3 is an enlarged, fragmentary, cross-sectional view of a cross-section A of a second exemplary embodiment of the thermoplastic laminate of FIG. 1 along section line II-II;

FIG. 4 is an enlarged, fragmentary, cross-sectional view of a cross-section A of a third exemplary embodiment of the thermoplastic laminate of FIG. 1 along section line II-II;

FIG. 5 is a side elevational view of an exemplary embodiment of a machine layout for coupling thermoplastic layers to one other; and

FIG. 6 is an enlarged, fragmentary, side elevational view of a portion B of the machine layout of FIG. 5.

### DETAILED DESCRIPTION OF THE EMBODIMENTS

As required, detailed embodiments of the systems, apparatuses, and methods are disclosed herein; however, it is to be understood that the disclosed embodiments are merely exemplary of the systems, apparatuses, and methods, which can be embodied in various forms. Therefore, specific structural and functional details disclosed herein are not to be interpreted as limiting, but merely as a basis for the claims and as a representative basis for teaching one skilled in the art to variously employ the systems, apparatuses, and methods in virtually any appropriately detailed structure. Further, the terms and phrases used herein are not intended to be limiting; but rather, to provide an understandable description of the systems, apparatuses, and methods. While the specification concludes with claims defining the features of the systems, apparatuses, and methods that are regarded as novel, it is believed that the systems, apparatuses, and methods will be better understood from a consideration of the following description in conjunction with the drawing figures, in which like reference numerals are carried forward.

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Alternate embodiments may be devised without departing from the spirit or the scope of the invention. Additionally, well-known elements of exemplary embodiments of the systems, apparatuses, and methods will not be described in detail or will be omitted so as not to obscure the relevant details of the systems, apparatuses, and methods.

Before the systems, apparatuses, and methods are disclosed and described, it is to be understood that the terminology used herein is for the purpose of describing particular embodiments only and is not intended to be limiting. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element. The terms “including” and/or “having,” as used herein, are defined as comprising (i.e., open language). The terms “a” or “an”, as used herein, are defined as one or more than one. The term “plurality,” as used herein, is defined as two or more than two. The term “another,” as used herein, is defined as at least a second or more. The description may use the terms “embodiment” or “embodiments,” which may each refer to one or more of the same or different embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact (e.g., directly coupled). However, “coupled” may also mean that two or more elements are not in direct contact with each other, but yet still cooperate or interact with each other (e.g., indirectly coupled).

For the purposes of the description, a phrase in the form “A/B” or in the form “A and/or B” or in the form “at least one of A and B” means (A), (B), or (A and B), where A and B are variables indicating a particular object or attribute. When used, this phrase is intended to and is hereby defined as a choice of A or B or both A and B, which is similar to the phrase “and/or”. Where more than two variables are present in such a phrase, this phrase is hereby defined as including only one of the variables, any one of the variables, any combination of any of the variables, and all of the variables, for example, a phrase in the form “at least one of A, B, and C” means (A), (B), (C), (A and B), (A and C), (B and C), or (A, B and C).

Relational terms such as first and second, top and bottom, and the like may be used solely to distinguish one entity or action from another entity or action without necessarily requiring or implying any actual such relationship or order between such entities or actions. The description may use perspective-based descriptions such as up/down, back/front, top/bottom, and proximal/distal. Such descriptions are merely used to facilitate the discussion and are not intended to restrict the application of disclosed embodiments. Various operations may be described as multiple discrete operations in tum, in a manner that may be helpful in understanding embodiments; however, the order of description should not be construed to imply that these operations are order dependent.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one skilled in the art would know to be a reasonable tolerance for the parts mentioned.

Herein various embodiments of the systems, apparatuses, and methods are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

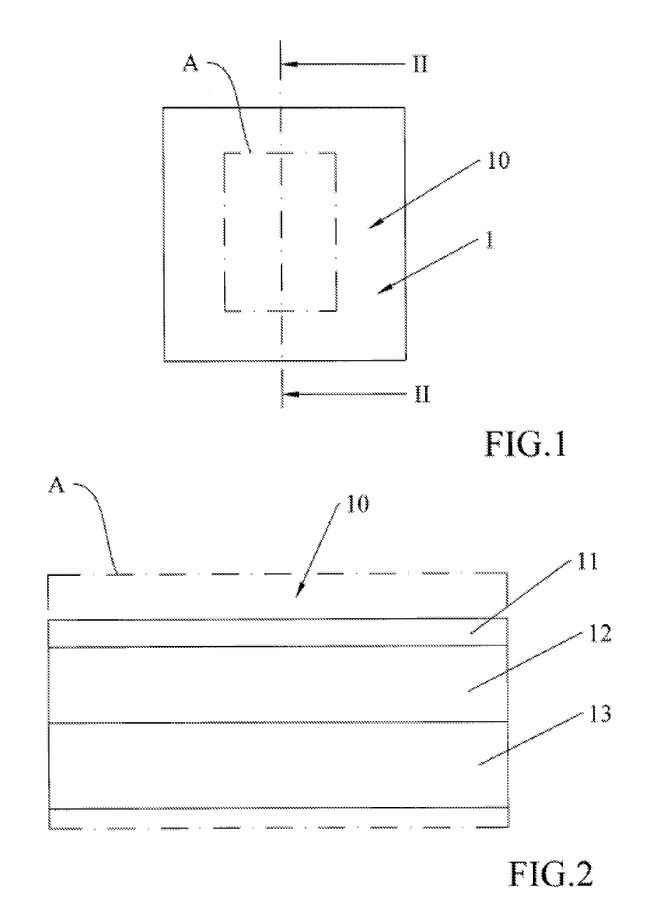

Described now are exemplary embodiments. Referring now to the figures of the drawings in detail and first, particularly to FIGS. 1 to 4, there is shown a first exemplary embodiment of a thermoplastic laminate 1 comprising a multiplicity of thermoplastic layers 11 to 18 that comprises at least one superficial thermoplastic layer 11 and at least two basic thermoplastic layers 12, 13, 14, 15, 16, 17, 18 (which also can be referred to as base thermoplastic layers or base layers). The multiple thermoplastic layers 11 to 18 are coupled to one another without glue by a superficial heating of coupling surfaces and by pressing one onto another.

The superficial thermoplastic layer 11 is a thin film of any one of materials of a list comprising PVC, PET, PETG, PP, and PE. The superficial thermoplastic layer 11 may be rigid or semi-rigid. The superficial thermoplastic layer 11 may be a crystal (e.g., clear) or a superficial layer treated with a finishing paint. If the superficial thermoplastic layer 11 is a crystal, then the plasticization of the crystal superficial thermoplastic layer 11 is from 10 to 30 phr (parts per hundred of resin). The crystal superficial thermoplastic layer 11 may be filled with mineral filers included in a list comprising any one or more of TiO₂, calcium carbonate, silica, and talc. The crystal superficial thermoplastic layer 11 is transparent to protect the printing underneath. Alternatively, the superficial thermoplastic layer 11 treated with paint finishing may also be applied to TU products.

Each of the at least two basic thermoplastic layers 12 to 18 is a film made of any one of materials of a list comprising PVC, PET, PETG, PP, and PE. Each of the at least two basic thermoplastic layers 12 to 18 is rigid and free of plasticizers. The basic thermoplastic layers 12 to 18 can be colored.

The single basic thermoplastic layers 11 to 18 are made using manufacturing technological of the prior art known as calendering and extruding.

The thermoplastic laminate 1 comprises a sheet 10 having a thickness from 0.75 mm to 4 mm. The sheet 10 of thermoplastic laminate 1 is plane (or planar), flat, and rigid so as to keep advantageous flat. By being “rigid,” this means that the sheet 10 of thermoplastic laminate 1 is not wound in coils but is kept in the form of a flat sheet 10. The sheet 10 of thermoplastic laminate 1 is applied by pressing or gluing to the surfaces of pieces of furniture or wood structures or particleboard materials.

The sheet 10 of thermoplastic laminate 1 may be of solid color or printed with different decorations, with different surface finishes, from smooth to deeply engraved, either registered or not. Superficial protection paints can also be applied to the sheet 10.

An exemplary method of manufacturing the sheet 10 of thermoplastic material 1 comprises single couplings, i.e., coupling between two single layers 11 to 18, which form combined thermoplastic multilayers, and combined couplings, i.e., couplings between combined thermoplastic multilayers, which were previously coupled according to single couplings without the use of glue between one layer and the other of the multiplicity of thermoplastic layers 11 to 18.

As shown in FIGS. 1 and 2, a first exemplary embodiment includes a sheet 10 of thermoplastic laminate 1 for surfaces of pieces of furniture or structures made of wood or particleboard materials comprising a superficial thermoplastic layer 11 and two basic thermoplastic layers 12 and 13. The superficial thermoplastic layer 11 is transparent and is 100 micrometers thick. Each of the two basic thermoplastic layers 12 and 13 is 350 micrometers thick. The sheet 10 is 800 micrometers thick, i.e., 0.8 mm.

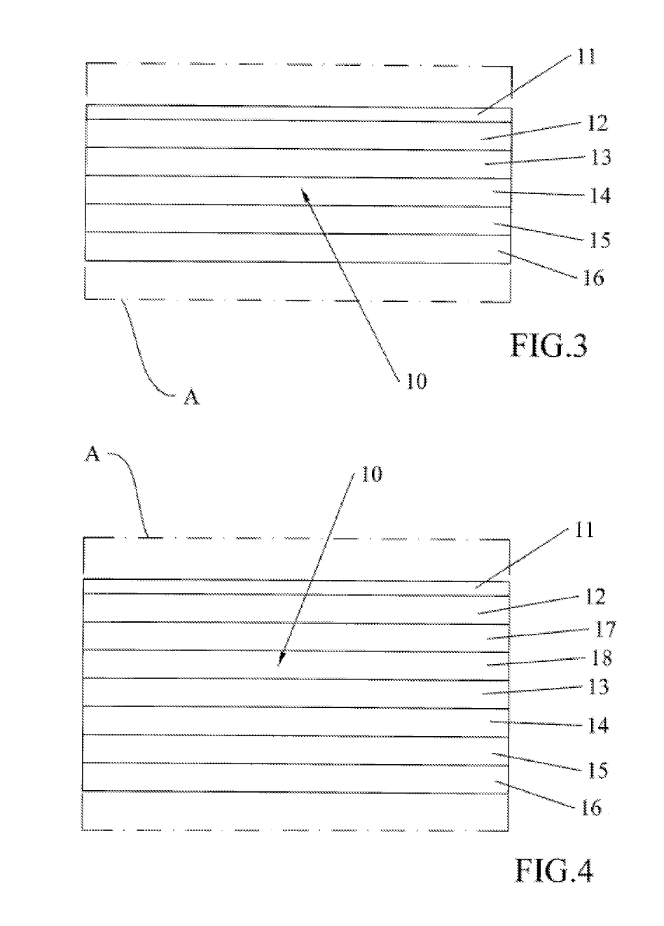

In a second exemplary embodiment, the sheet 10 of thermoplastic laminate 1 comprises a superficial thermoplastic layer 11 and five basic thermoplastic layers 12, 13, 14, 15, 16, as shown in FIG. 3. The superficial thermoplastic layer 11 is transparent and is 100 micrometers thick. Each of the five basic thermoplastic layers 12 to 16 is 350 micrometers thick. The sheet 10 is 1850 micrometers thick, i.e. 1.85 mm.

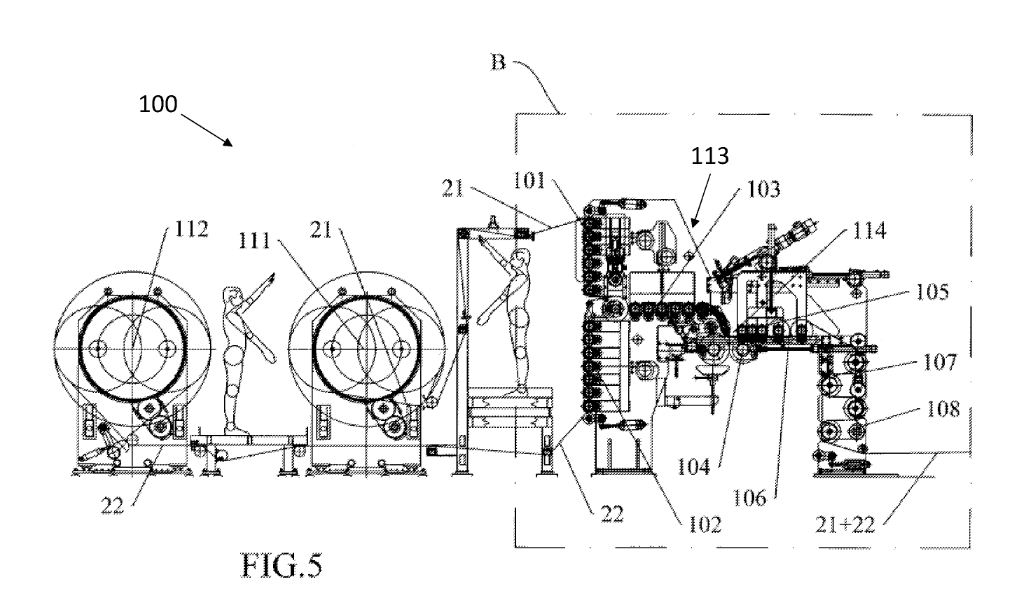

In a third exemplary embodiment, the sheet 10 of thermoplastic laminate 1 comprises a superficial thermoplastic layer 11 and eight basic thermoplastic layers 12, 13, 14, 15, 16, 17, 18, as shown in FIG. 4. The superficial thermoplastic layer 11 is transparent and is 100 micrometers thick. Each of the eight basic thermoplastic layers 12 to 18 is 350 micrometers thick. The sheet 10 is 2550 micrometers thick, i.e., 2.55 mm.

The thickness of the thermoplastic laminate sheet 1 is from 0.8 mm to 2.55 mm. Starting from different thicknesses of the thermoplastic layers 11 to 18, a thickness from 0.75 mm to 4 mm may be provided for the sheet 10 of thermoplastic laminate 1.

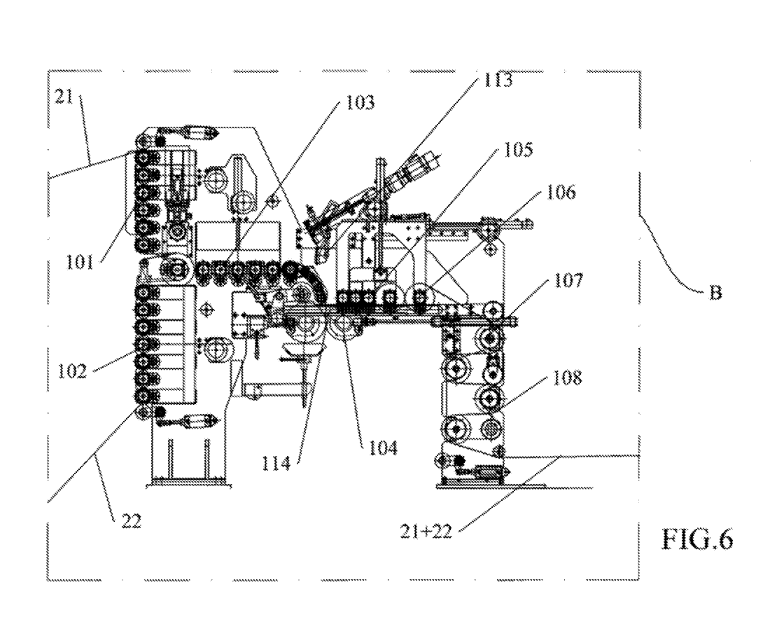

A sheet 10 of thermoplastic laminate 1 advantageously comprises only a multiplicity of thermoplastic layers 11 to 18, which comprises at least one superficial thermoplastic layer 11 and at least two basic thermoplastic layers 12 to 18, the multiple thermoplastic layers 11 to 18 are made of any one of materials of a list comprising PVC, PET, PETG, PP, and PE. The sheet 10 of thermoplastic laminate 1 comprises only at least one superficial thermoplastic layer 11 and at least two basic thermoplastic layers 12 to 18. The multiple thermoplastic layers 11 to 18 are coupled to one another without glue by a superficial heating of coupling surfaces and pressing onto one another, i.e., every first layer 21 of the multiplicity of thermoplastic layers 11 to 18 is coupled to a second layer 22 of the multiplicity of thermoplastic layers 11 to 18 without glue by superficial heating of the coupling surfaces of the first layer 21 with the second layer 22 and pressing between the first layer 21 and the second layer 22. When using the general terms “first layer 21” and “second layer 22” herein, the inventors are referring to any one of the plurality of layers 11 to 18 as the first layer and any other one of the plurality layers 11 to 18 as the second layer as will be further described with regard to FIGS. 5 and 6 below. The thickness of the thermoplastic laminate sheet 1 is greater than 0.7 mm, i.e., from 0.75 mm to 4 mm. The sheet 10 of thermoplastic laminate 1 is plane, flat, and rigid.

The at least one superficial thermoplastic layer 11 is advantageously a thin thermoplastic film and has a plasticization from 10 to 30 parts per hundred of resin. The at least two basic thermoplastic layers 12 to 18 are rigid and free of plasticizers.

The at least one superficial thermoplastic layer 11 is 100 micrometers thick and each of the at least two basic thermoplastic layers 12 to 18 is 350 micrometers thick.

One outer surface of the sheet 10 of thermoplastic laminate 1 is advantageously embossed.

Advantageously, the mechanical shock resistance properties of the sheet 10 of thermoplastic laminate 1 are comparable to those of a sheet of HPL decorative laminated products. The resistance index of the sheet 10 of thermoplastic laminate 1 is 60 inches for ball impact resistance and 25 inches for dart impact resistance, values that are similar to those of the HPL sheet, which are 55 inches and of 22 inches, respectively, as shown in Table 2-1 of American standard ANSI/NEMA LD 3-2005. Further measurements indicate that the dart impact resistance of the sheet 10 of thermoplastic laminate 1 is 28 inches, which is considerably better than the HPL sheet. Advantageously, the sheet 10 of thermoplastic laminate 1 has mechanical properties of resistance to stress and to shocks comparable to and better than the HPL sheets. A sheet 10 of thermoplastic laminate 1 less than approximately 0.8 mm thick +/−0.05 mm does not achieve the technical resistance properties comparable to those of HPL sheets.

Advantageously, the sheet 10 of thermoplastic laminate 1 has flatness properties comparable and even much better than those of a sheet of HPL decorative laminate products. As set forth above with reference to table 2.4 of the American standard ANSI/NEMA LD 3-2005, a flatness test measures and records the thickness of a sheet in all corners of the sheet and at mid-point of each side of the sheet, according to the technical procedures explained in paragraph 3.1.5 of the American standard ANSI/NEMA LS 3-2005. For HPL sheets, a result of this flatness test is +/−120 mm for the single-face HPL sheet less than 2 mm thick and is +/−50 mm for the single-face HPL sheet thicker than 2 mm. In comparison, the sheet 10 of thermoplastic laminate 1 produced according to the process herein with a thickness of 0.8 mm +/−0.05 mm has a flatness test result of +/−3 mm—which is considerably and advantageously better than the flatness of the HPL sheets and is, at a minimum, more than ten times flatter than HPL sheets. In particular, the flatness measurement of such a sheet 10 of thermoplastic laminate 1 is from −3 mm to +3 mm.

Better flatness properties of the sheet 10 of thermoplastic laminate 1 allows one to apply sheets 10 of thermoplastic laminate 1 to surfaces of pieces of furniture or structures made of wood or particleboard materials with use of less glue. Advantageously, the extreme and surprising flatness of the sheet 10 of thermoplastic laminate can reduce the deformation and avoid edges that bend upwards in the corners, thus facilitating the application of the sheet 10 to such surfaces.

Advantageously, the sheet 10 of thermoplastic laminate 1 allows the sheet 10 of thermoplastic laminate 1, once applied to such surfaces, not to crack on the edges, because the sheet 10 once glued is subject to less stress. Fewer stresses are due to the fact that the layers of thermoplastic material that form the sheet 10 are uniform and homogeneous, and thus greatly reduce the stresses that crack the HPL sheets, the constructional layers of which are instead different and glued together. HPL sheets have a dimensional stability of 0.70% in the direction of the sheet-manufacturing machine and a dimensional stability of 1.20% in the crosswise direction. The sheets 10 of thermoplastic laminate 1 instead maintain a much more homogeneous and much more uniform thickness, with a dimensional stability lower than 0.2% both in the direction of the machine and in the crosswise direction.

Comprising only thermoplastic layers made of materials from the list comprising PVC, PET, PETG, PP, and PE, the sheet 10 of thermoplastic laminate 1 allows the avoidance of humidity-related problems or problems of application to such surfaces in humid environments because the materials from the list do not suffer from humidity-related problems.

Advantageously, the sheet 10 of thermoplastic laminate 1 allows it to maintain color uniformity along the entire thickness of the sheet 10. The surface resistance of an HPL sheet is attested at 400 cycles a minute, while the surface resistance of the sheet 10 of thermoplastic laminate 1 is attested at over 1500 cycles for printed sheets and at over 4000 cycles for sheets of uniform color.

The sheet 10 of thermoplastic laminate 1 provides all the advantages of the technical properties of HPL sheets, even improving those advantageous technical properties and further solving all the disadvantages of the HPL sheets.

Advantageously, the sheet 10 of thermoplastic laminate 1 can be easily post-formed and can further improve appearance because the sheet 10 of thermoplastic laminate 1 has uniform color on the entire outer surface. In comparison, color uniformity on the outer surface of HPL sheets may be obtained only with longer, more complicated and uneconomical manufacturing processes. Known post-forming techniques of HPL sheets include, as first step, a shaping of the substrate according to a curved profile of a support, which is a structure made of wood or particleboard materials. The substrate is then glued by adhering it completely to the support in a flat zone and in a curved zone. The post-forming radius at room temperature for the HPL sheets is 13 mm. In comparison, the sheet 10 of thermoplastic laminate 1 has a post-forming radius at room temperature of 8 mm, which is considerably better than that of the HPL sheets.

The method of manufacturing the sheet 10 of thermoplastic laminate 1 according to the three exemplary embodiments is implemented by a machine 100 having rollers 101 to 108, 111, 112 as shown in FIGS. 5 and 6. A coupling cycle on the machine 100 is needed to couple a first layer 21 and a second layer 22.

The machine 100 comprises a first coil 111 (also referred to as a cylinder or roller), which winds (or rolls up) a first layer 21 of any one of the thermoplastic layers 11 TO 18 or of any one of the combined thermoplastic multilayers and adjusts a sliding speed of the first layer 21.

The adjustment of the sliding speed advantageously permits keeping the first layer 21 taut, thus preventing the formation of deformities, folds, or stretching that deform the first layer 21.

The machine 100 also comprises a second coil 112 (also referred to as a cylinder or roller), which winds (or rolls up) a second layer 22 of any one of the thermoplastic layers 11 to 18 or of any one of the combined thermoplastic multilayers and controls a sliding speed of the second layer 22.

The adjustment of the sliding speed allows advantageously permits keeping the second layer 22 taut, thus preventing the formation of deformities, folds, or stretching that deform the second layer 22.

The machine 100 comprises a first multiplicity of comb rollers 101 and a second multiplicity of comb rollers 102.

The first multiplicity of comb rollers 101 rotates at a first speed V1 and allows for adjusting of the sliding speed of the first layer 21 and keeping the first layer 21 taut and pre-heating it by a fluid, e.g., a diathermic oil, the first inlet temperature Ti-1 of which is measured by or for users of the machine 100.

The second multiplicity of comb rollers 102 rotates at a second speed V2 and allows for adjusting the sliding speed of the second layer 22 and keeping the second layer 22 taut and pre-heating it by the fluid, the first inlet temperature Ti-2 of which is measured by or for users of the machine 100.

The machine 100 comprises a third multiplicity of coupling rollers 103. The coupling rollers 103 are downstream of the first multiplicity of comb rollers 101 and downstream of the second multiplicity of comb rollers 102. The coupling rollers 103 press together the first layer 21 and the second layer 22 to form a combined multilayer 21+22. Fluid delivered to the multiplicity of coupling rollers 103 has a third input temperature Ti-3. The third multiplicity of rollers 103 has a third rotation speed V3. The third rotation speed V3 allows coupling of the first layer 21 and the second layer 22 without stretching, folding, or delamination and without damaging the layers 21, 22. The third rotation speed V3 of the third multiplicity of rollers 103 contributes to keeping the combined multilayer 21+22 correctly taut.

Said coupling rollers 103 mount a heater, e.g., a multiplicity of infrared heating lamps 113, to the machine 100, which lamps 113 heat the combined multilayer 21+22 while it passes on the coupling rollers 103. These infrared lamps 113 promote the coupling of the first layer 21 to the second layer 22.

The machine 100 comprises a fourth roller 104, which may impart a smooth surface or a surface with a pattern to have the function of an embossing roller 104 for the outer surface of the sheet 10 of thermoplastic laminate 1 when needed during the method of manufacturing the sheet 10 of thermoplastic laminate 1. The fourth roller 104 is mounted downstream of the multiplicity of coupling rollers 103. Fluid delivered to the fourth roller 104 has a fourth input temperature Ti-4. A temperature-measuring device 114 is at the inlet of the fourth roller 104. In an exemplary embodiment, the temperature-measuring device 114 is an infrared ray sensor that measures a temperature T4 of the combined multilayer 21+22 after it was heated by the infrared lamps 113. The fourth roller 104 has a rotation speed V4 that contributes together with the other speeds V1, V2, and V3 to keeping the combined multilayer 21+22 taut, thus preventing the formation of deformities and folds.

The machine 100 comprises a fifth multiplicity of rollers 105 that rotate at a fifth speed V5. The delivery fluid input to the fifth multiplicity of rollers 105 has a fifth input temperature Ti-5.

The machine 100 comprises a sixth multiplicity of rollers 106 that rotate at a sixth speed V6. The delivery fluid input to the sixth multiplicity of rollers 106 has a sixth input temperature Ti-6.

The machine 100 comprises a seventh multiplicity of rollers 107 that rotate at a seventh speed V7. The delivery fluid input to the seventh multiplicity of rollers 107 has a seventh input temperature Ti-7.

The machine 100 comprises an eighth multiplicity of rollers 108 that rotate at an eighth speed V8. The delivery fluid input to the eighth multiplicity of rollers 108 has an eighth input temperature Ti-8.

The fifth, sixth, seventh, and eighth pluralities of rollers 105 to 108 contribute to keeping the combined multilayer 21+22 taut, avoiding deformations and contributing to a gradual cooling of the combined multilayer 21+22, which would otherwise be subject to differences of temperature that could compromise flatness, homogeneousness, and uniformity.

The speeds V1 to V8 allow the combined multilayer 21+22 to remain homogeneous and uniform without folds, without deformities, and with high flatness properties.

A cycle of the machine 100, therefore, couples the first layer 21 to the second layer 22 forming a combined multilayer 21+22. At the end of the machine cycle, either the combined multilayer 21+22 can be restarted for a further combined coupling with another combined multilayer previously formed by a previous cycle of the machine 100 or the cycle can be ended.

At the end of the cycle, a cutter or cutters are provided in line with the machine 100, such as, for example, a guillotine or rotating cutter (not shown in the figures) downstream of the machine 100 after the eighth multiplicity of rollers 108. The cutter(s) cuts the sheets 10 of thermoplastic laminate 1 to a desired size. The sheets 10 of thermoplastic laminate 1 are on a flat support to then be stored for use.

The method of manufacturing the sheet 10 of thermoplastic laminate 1 according to the first exemplary embodiment comprises a multiplicity of couplings between the thermoplastic layers 11 to 13.

The manufacturing method comprises a first single coupling between the superficial thermoplastic layer 11 and the first basic thermoplastic layer 12, this first single coupling forming a first combined thermoplastic multilayer 11+12, which is 450 micrometers thick.

In this first single coupling, the superficial thermoplastic layer 11 is the first layer 21 and the second basic thermoplastic layer 12 is the second layer 22, which is coupled according to the cycle of the machine 100.

The first input temperature Ti-1 of the fluid that acts on the superficial thermoplastic layer 11 in the first multiplicity of comb rollers 101 is from 55 to 75 degrees ° C. The first speed V1 of the first multiplicity of the comb rollers 101 is from 4 to 14 m/min.

The second input temperature Ti-2 of the fluid that acts on the basic thermoplastic layer 12 in the second multiplicity of comb rollers 102 is from 100 to 130 degrees ° C. The second speed V2 of the second multiplicity of the comb rollers 102 is from 4.1 to 14.1 m/min.

The third input temperature Ti-3 of the fluid to the third multiplicity of coupling rollers 103 is from 130 to 170 degrees ° C., while the third speed V3 of the rollers of the multiplicity of coupling rollers 103 is from 4.1 to 14.1 m/min.

An embossing operation may be included at the end of the first single coupling. Advantageously, the embossing operation is performed only after the first single coupling between the superficial thermoplastic layer 11 and the first basic thermoplastic layer 12 to preserve an outer surface of the first combined thermoplastic multilayer 11+12. This outer surface is exposed to the outside of the sheet 10 of thermoplastic laminate 1 and corresponds to an outer surface of the superficial thermoplastic layer 11. The embossing operation acts to give a desired pattern to the outer surface of the first combined thermoplastic multilayer 11+12.

The embossing operation provides for the fourth roller 104 of the machine 100 to impart a surface comprising the embossing pattern. The fourth input temperature Ti-4 of the delivery fluid on the fourth roller 104 is from 70 to 110 degrees ° C., while the fourth speed V4 of the rollers of fourth roller 104 is from 4.2 to 14.2 m/min.

The temperature T4 of the first combined thermoplastic multilayer 11+12 at the inlet of the fourth roller 104 is from 145 to 195 degrees ° C.

The fifth input temperature Ti-5 of the delivery fluid to the fifth multiplicity of coupling rollers 105 is from 50 to 70 degrees ° C., while the fifth speed V5 of the fifth multiplicity of rollers 105 is from 4.3 to 14.3 m/min.

The sixth input temperature Ti-6 of the delivery fluid to the sixth multiplicity of rollers 106 is from 40 to 65 degrees ° C., while the sixth speed V6 of the sixth multiplicity of rollers 106 is from 4.6 to 14.6 m/min.

The seventh input temperature Ti-7 of the delivery fluid to the seventh multiplicity of rollers 107 is from 35 to 55 degrees ° C., while the seventh speed V7 of the seventh multiplicity of rollers 107 is from 4.6 to 14.6 m/min.

The eighth input temperature Ti-8 of the delivery fluid to the eighth multiplicity of rollers 108 is from 25 to 45 degrees ° C., while the eighth speed V8 of the eighth multiplicity of rollers 108 is from 4.6 to 14.6 m/min.

The method comprises a first combined coupling between the first combined thermoplastic multilayer 11+12 and a second basic thermoplastic layer 13, this first combined coupling forms the sheet 10 of thermoplastic laminate 1 according to the first exemplary embodiment. The sheet 10 is approximately 800 micrometers thick, i.e., 0.8 mm +/−0.05 mm.

The last combined coupling includes a further machine cycle, in which the first combined thermoplastic multilayer 11+12 is the first layer 21 and the second basic thermoplastic layer 13 is the second layer 22, which layers 21 and 22 are coupled according to the cycle of the machine 100.

The first input temperature Ti-1 of the fluid that acts on the first combined thermoplastic multilayer 11+12 in the first multiplicity of comb rollers 101 is from 115 to 145 degrees ° C. The first speed V1 of the first multiplicity of the comb rollers 101 is from 2.7 to 12.7 m/min.

The second input temperature Ti-2 of the fluid that acts on the second basic thermoplastic layer 13 in the second multiplicity of comb rollers 102 is from 100 to 130 degrees ° C. The second speed V2 of the second multiplicity of the comb rollers 102 is from 2.7 to 12.7 m/min.

The third input temperature Ti-3 of the fluid to the third multiplicity of coupling rollers 103 is from 120 to 180 degrees ° C., while the third speed V3 of the rollers of the multiplicity of coupling rollers 103 is from 3 to 13 m/min.

The fourth input temperature Ti-4 of the delivery fluid on the fourth roller 104 is from 74 to 114 degrees ° C., while the fourth speed V4 of the rollers of fourth roller 104 is from 2.6 to 12.6 m/min.

The temperature T4 of the sheet 10 at the inlet of the fourth roller 104 is from 150 to 200 degrees ° C.

The fifth input temperature Ti-5 of the delivery fluid to the fifth multiplicity of coupling rollers 105 is from 60 to 80 degrees ° C., while the fifth speed V5 of the fifth multiplicity of rollers 105 is from 2.7 to 12.7 m/min.

The sixth input temperature Ti-6 of the delivery fluid to the sixth multiplicity of rollers 106 is from 50 to 70 degrees ° C., while the sixth speed V6 of the sixth multiplicity of rollers 106 is from 2.8 to 12.8 m/min.

The seventh input temperature Ti-7 of the delivery fluid to the seventh multiplicity of rollers 107 is from 40 to 60 degrees ° C., while the seventh speed V7 of the seventh multiplicity of rollers 107 is from 2.8 to 12.8 m/min.

The eighth input temperature Ti-8 of the delivery fluid to the eighth multiplicity of rollers 108 is from 30 to 50 degrees ° C., while the eighth speed V8 of the eighth multiplicity of rollers 108 is from 2.8 to 7.8 m/min.

At the end of the cycle of the machine 100, the sheet 10 of thermoplastic laminate 1 is sent to the cutter(s) in line with the machine 100 to cut the sheet 10 to desired dimensions.

The method of manufacturing the sheet 10 of thermoplastic laminate 1 according to the second exemplary embodiment of FIG. 3 includes a multiplicity of couplings between the thermoplastic layers 11 to 16 as will be described below.

The manufacturing method comprises the first single coupling between the superficial thermoplastic layer 11 and a first basic thermoplastic layer 12, the first single coupling forms the first combined thermoplastic multilayer 11+12, which is 450 micrometers thick. The first single coupling passes the superficial thermoplastic layer 11 and the first basic thermoplastic layer 12 through the cycle of the machine 100. The temperatures Ti-1 to Ti-8 and the speeds V1 to V8 are those of the first single coupling of the first embodiment.

The method comprises a second single coupling between the second basic thermoplastic layer 13 and a third basic thermoplastic layer 14, this second single coupling forms a second combined thermoplastic multilayer 13+14 which is 700 micrometers thick.

The first input temperature Ti-1 of the fluid that acts on the second basic thermoplastic layer 13 in the first multiplicity of comb rollers 101 is from 100 to 120 degrees ° C. The first speed V1 of the first multiplicity of the comb rollers 101 is from 3.5 to 12.5 m/min.

The second input temperature Ti-2 of the fluid that acts on the third basic thermoplastic layer 14 in the second multiplicity of comb rollers 102 is from 100 to 120 degrees ° C. The second speed V2 of the second multiplicity of the comb rollers 102 is from 3.5 to 12.5 m/min.

The third input temperature Ti-3 of the fluid to the third multiplicity of coupling rollers 103 is from 150 to 170 degrees ° C., while the third speed V3 of the rollers of the multiplicity of coupling rollers 103 is from 3.6 to 12.6 m/min.

The fourth input temperature Ti-4 of the delivery fluid on the fourth roller 104 is from 100 to 120 degrees ° C., while the fourth speed V4 of the rollers of fourth roller 104 is from 3.8 to 12.8 m/min.

The temperature T4 of the combined multilayer 13+14 at the inlet of the fourth roller 104 is from 160 to 200 degrees ° C.

The fifth input temperature Ti-5 of the delivery fluid to the fifth multiplicity of coupling rollers 105 is from 60 to 80 degrees ° C., while the fifth speed V5 of the fifth multiplicity of rollers 105 is from 4.2 to 14.2 m/min.

The sixth input temperature Ti-6 of the delivery fluid to the sixth multiplicity of rollers 106 is from 50 to 70 degrees ° C., while the sixth speed V6 of the sixth multiplicity of rollers 106 is from 4.2 to 14.2 m/min.

The seventh input temperature Ti-7 of the delivery fluid to the seventh multiplicity of rollers 107 is from 40 to 60 degrees ° C., while the seventh speed V7 of the seventh multiplicity of rollers 107 is from 4.2 to 14.2 m/min.

The eighth input temperature Ti-8 of the delivery fluid to the eighth multiplicity of rollers 108 is from 30 to 50 degrees ° C., while the eighth speed V8 of the eighth multiplicity of rollers 108 is from 4.2 to 14.2 m/min.

The method comprises a third single coupling between a fourth basic thermoplastic layer 15 and a fifth basic thermoplastic layer 16, this third single coupling forms a third combined thermoplastic multilayer 15+16 which is 700 micrometers thick. The temperatures Ti-1 to Ti-8 and the speeds V1 to V8 are those of the second single coupling of the second embodiment.

The method comprises a first combined coupling between the second combined thermoplastic multilayer 13+14 and the third combined thermoplastic multilayer 15+16, this first combined coupling forms a penultimate combined thermoplastic multilayer 13+14+15+16 that is 1400 micrometers thick.

The first combined coupling between the second combined thermoplastic multilayer 13+14 and the third combined thermoplastic multilayer 15+16 includes performing the machine cycle with the first input temperature Ti-1 of the fluid that acts on the second combined thermoplastic multilayer 13+14 of the first multiplicity of comb rollers 101 from 140 to 160 degrees ° C. The first speed V1 of the first multiplicity of the comb rollers 101 is from 1.5 to 11.5 m/min.

The second input temperature Ti-2 of the fluid that acts on the third combine thermoplastic multilayer 15+16 in the second multiplicity of comb rollers 102 is from 130 to 150 degrees ° C. The second speed V2 of the second multiplicity of the comb rollers 102 is from 1.5 to 11.5 m/min.

The third input temperature Ti-3 of the fluid to the third multiplicity of coupling rollers 103 is from 155 to 185 degrees ° C., while the third speed V3 of the rollers of the multiplicity of coupling rollers 103 is from 1.6 to 11.6 m/min.

The fourth input temperature Ti-4 of the delivery fluid on the fourth roller 104 is from 110 to 130 degrees ° C., while the fourth speed V4 of the rollers of fourth roller 104 is from 1.8 to 11.8 m/min.

The temperature T4 at the inlet of the fourth roller 104 is from 170 to 220 degrees ° C.

The fifth input temperature Ti-5 of the delivery fluid to the fifth multiplicity of coupling rollers 105 is from 60 to 80 degrees ° C., while the fifth speed V5 of the fifth multiplicity of rollers 105 is from 2.1 to 12.1 m/min.

The sixth input temperature Ti-6 of the delivery fluid to the sixth multiplicity of rollers 106 is from 50 to 70 degrees ° C., while the sixth speed V6 of the sixth multiplicity of rollers 106 is from 2.1 to 12.1 m/min.

The seventh input temperature Ti-7 of the delivery fluid to the seventh multiplicity of rollers 107 is from 40 to 60 degrees ° C., while the seventh speed V7 of the seventh multiplicity of rollers 107 is from 2.1 to 12.1 m/min.

The eighth input temperature Ti-8 of the delivery fluid to the eighth multiplicity of rollers 108 is from 30 to 50 degrees ° C., while the eighth speed V8 of the eighth multiplicity of rollers 108 is from 2.1 to 12.1 m/min.

The method includes the last combined coupling between the first thermoplastic multilayer 11+12 and the penultimate combined thermoplastic multilayer 13+14+15+16. This last combined coupling forms the sheet 10 of thermoplastic laminate 1 according to the second exemplary embodiment shown in FIG. 3. The sheet 10 is 1850 micrometers thick, i.e., 1.85 mm.

An embossing operation may be provided at the end of the last combined coupling. Advantageously, the embossing operation is provided only after the last combined coupling to preserve the outer surface of the first combined thermoplastic multilayer 11+12. The embossing operation acts to provide the desired pattern of the sheet 10 of thermoplastic laminate 1.

The last combined coupling includes performing the machine cycle with the first input temperature Ti-1 of the fluid into the first multiple of comb rollers 101 from 110 to 130 degrees ° C. The first speed V1 of the first multiplicity of the comb rollers 101 is from 0.3 to 10.3 m/min.

The second input temperature Ti-2 of the fluid in the second multiplicity of comb rollers 102 is from 140 to 160 degrees ° C. The second speed V2 of the second multiplicity of the comb rollers 102 is from 0.3 to 10.3 m/min.

The third input temperature Ti-3 of the fluid to the third multiplicity of coupling rollers 103 is from 150 to 180 degrees ° C., while the third speed V3 of the rollers of the multiplicity of coupling rollers 103 is from 1.5 to 10.5 m/min.

The fourth input temperature Ti-4 of the delivery fluid on the fourth roller 104 is from 100 to 120 degrees ° C., while the fourth speed V4 of the rollers of fourth roller 104 is from 0.4 to 10.4 m/min.

The temperature T4 at the inlet of the fourth roller 104 is from 165 to 200 degrees ° C.

The fifth input temperature Ti-5 of the delivery fluid to the fifth multiplicity of coupling rollers 105 is from 60 to 80 degrees ° C., while the fifth speed V5 of the fifth multiplicity of rollers 105 is from 0.5 to 10.5 m/min.

The sixth input temperature Ti-6 of the delivery fluid to the sixth multiplicity of rollers 106 is from 50 to 70 degrees ° C., while the sixth speed V6 of the sixth multiplicity of rollers 106 is from 0.5 to 10.5 m/min.

The seventh input temperature Ti-7 of the delivery fluid to the seventh multiplicity of rollers 107 is from 40 to 60 degrees ° C., while the seventh speed V7 of the seventh multiplicity of rollers 107 is from 0.6 to 10.6 m/min.

The eighth input temperature Ti-8 of the delivery fluid to the eighth multiplicity of rollers 108 is from 30 to 50 degrees ° C., while the eighth speed V8 of the eighth multiplicity of rollers 108 is from 0.6 to 10.6 m/min.

The sheet 10 is then cut by the cutter(s) in line with the machine 100.

The method of manufacturing the sheet 10 of thermoplastic laminate 1 according to the third embodiment of FIG. 4 includes a multiplicity of couplings between the thermoplastic layers 11 to 18 as described in further detail below.

The manufacturing method comprises the first single coupling between the superficial thermoplastic layer 11 and a first basic thermoplastic layer 12, this first single coupling forms the first combined thermoplastic multilayer 11+12, which is 450 micrometers thick. The first single coupling passes the superficial thermoplastic layer 11 and the first basic thermoplastic layer 12 through the cycle of the machine 100. The temperatures Ti-1 to Ti-8 and the speeds V1 to V8 are those of the first single coupling of the first embodiment.

The method comprises the second single coupling between the second basic thermoplastic layer 13 and a third basic thermoplastic layer 14, this second coupling forms a second combined thermoplastic multilayer 13+14 that is 700 micrometers thick.

The method comprises the third single coupling between the fourth basic thermoplastic layer 15 and a fifth basic thermoplastic layer 16, this third single coupling forms a third combined thermoplastic multilayer 15+16 that is 700 micrometers thick.

The method comprises a fourth single coupling between a sixth basic thermoplastic layer 17 and a seventh basic thermoplastic layer 18, this fourth single coupling forms a fourth combined thermoplastic multilayer 17+18 that is 700 micrometers thick.

The method comprises the first combined coupling between the second combined thermoplastic multilayer 13+14 and a third combined thermoplastic multilayer 15+16, said first combined coupling forms a third to last combined thermoplastic multilayer 13+14+15+16 that is 1400 micrometers thick.

The method comprises a second combined coupling between the fourth combined thermoplastic multilayer 17+18 and the third to last combined thermoplastic multilayer 13+14+15+16, this second combined coupling forms a penultimate combined thermoplastic multilayer 17+18+13+14+15+16 that is 2100 micrometers thick.

The method includes the last combined coupling between the first thermoplastic multilayer 11+12 and the penultimate combined thermoplastic multilayer 17+18+13+14+15+16. This last combined coupling forms the sheet 10 of thermoplastic laminate 1 according to the third exemplary embodiment of FIG. 4. The sheet 10 is 2550 micrometers thick, i.e., 2.55 mm.

An embossing operation may be provided at the end of the last combined coupling. Advantageously, the embossing operation is provided only after the last combined coupling to preserve the outer surface of the first combined thermoplastic multilayer 11+12. The embossing operation acts to provide the desired pattern of the sheet 10 of thermoplastic laminate 1.

The methods of manufacturing the sheet 10 of thermoplastic laminate 1 according to the three exemplary embodiments described provide at the end of each coupling cooling of the combined thermoplastic multilayer before being used again for a further cycle of the machine 100 to couple it further to other layers or thermoplastic multilayer according to whether the coupling is single or combined.

Advantageously, in order to avoid deformations of the previously formed combined thermoplastic multilayers, the temperatures of the delivery fluid for use in the various multiplicity of rollers 101 to 108 is sufficient to make a contact surface between the first layer 21 and the second layer 22 reach the softening point. Temperatures Ti-1 to Ti8 and temperature T4 are chosen after field studies to prevent the entire thickness of the first layer 21 and the entire thickness of the second layer 22 from reaching a softening point that corresponds to a softening temperature that depends on the material of the thermoplastic layers 11-12 used. Advantageously, such temperatures Ti-1 to Ti-8 and temperature T4 are chosen only to soften the contact surface between the first layer 21 and the second layer 22 during the machine cycle 10 to promote the coupling by pressing of the first layer 21 and the second layer 22.

The speeds V1-V8 of the multiplicity of rollers 101-108 are chosen as a function of temperatures Ti-1 to Ti8 and of temperature T4 so that the first layer 21 and the second layer 22 can be coupled well without deformations and without stretching, so that all the combinations of the layers 21-22 and also of the sheet 10 of thermoplastic material 1 are advantageously homogeneous and uniform so as to have mechanical properties and resistance to stress and shocks comparable to those of HPL decorative laminate product sheets, to have flatness properties comparable to those of the HPL sheets, which are not subject to deformation and do not have edges which bend upwards in the corners, are easy to be applied to said surfaces, do not crack on the edges of the surfaces, do not have humidity-related problems nor have problems of application to the surfaces in humid environments, and have uniform color on the entire thickness of the sheet 10.

The speeds V1-V8 of the multiplicity of rollers 101-108 decreases as the thickness of the layers 21 and 22 that are being coupled increase, as shown in the three exemplary manufacturing methods described above for the three exemplary embodiments.

Sheets 10 of thermoplastic laminate 1 thicker than 4 mm are subject to manufacturing problems because, during the cycle of the machine 100, the combined thermoplastic laminate multilayer would be too thick and may not pass through the multiplicity of rollers 101 to 108, thus creating problems of flatness, homogeneousness, and uniformity of the thermoplastic laminate 1. Furthermore, the combined thermoplastic laminate multilayers very often become too rigid and cannot be pressed well by the coupling rollers 103 of the machine 100 and it becomes necessary to add a lot of glue to glue them as a consequence. The massive addition of glue (like in the known background art) would instead not achieve the technical properties comparable to those of the HPL sheet by the sheet 10 of thermoplastic laminate 1, which would no longer be sufficiently resistant to shocks and to mechanical stress as occurs as compared to the sheet 10 of thermoplastic laminate 1 described herein.

In brief, the method of manufacturing the sheet 10 of thermoplastic laminate 1 comprising only a multiplicity of thermoplastic layers 11 to 18 comprises a multiplicity of cycles, each cycle of this multiplicity of cycles including a first operation of heating only a contact surface between the first layer 21 and the second layer 22 to the softening point, which corresponds to the softening temperature. The first layer 21 and the second layer 22 are chosen from a list comprising a single thermoplastic layer 11 to 18 of the multiplicity of thermoplastic layers 11 to 18 and a second combined thermoplastic multilayer 11+12, 13+14, 15+16, 13+14+15+16, 17+18, 17+18+13+14+15+16 of a multiplicity of combined thermoplastic multilayers 11+12, 13+14, 15+16, 13+14+15+16, 17+18, 17+18+13+14+15+16 that were obtained during previous cycles of this multiplicity of cycles.

The first operation of heating only one contact surface between a first layer 21 and a second layer 22 occurs gradually in two steps, which may be performed in sequence or alternatively, a first step of these two steps that includes passing the first layer 21 and the second layer 22 in contact with a heated hydrodynamic fluid and a second step of these two steps, which provides heating the first layer 21 and the second layer 22 by heating lamps 113. No glues are used between the first layer 21 and the second layer 22.

The manufacturing method also includes a second operation of coupling by pressing the first layer 21 and the second layer 22 to obtain a combined multilayer 21+22 of the multiplicity of combined thermoplastic multilayers 11+12, 13+14, 15+16, 13+14+15+16, 17+18, 17+18+13+14+15+16.

This second coupling operation by pressing the first layer 21 and the second layer 22 has a sliding speed of the first layer 21 and of the second layer 22 that depends on the thickness of the first layer 21 and of the second layer 22, and this sliding speed decreases as a function of an increase of the thickness of the first layer 21 and of the second layer 22.

Finally, the manufacturing method comprises a third operation of cooling the combined multilayer 21+22 before proceeding with a further cycle of the multiplicity of cycles, this further cycle including the coupling of the combined multilayer 21+22 to another first or second layer 21, 22.

This third operating of cooling the combined multilayer 21+22 occurs gradually by passing the combined multilayer 21+22 through a multiplicity of cooling rollers 105 to 108 in line, which gradually put the combined multilayer 21+22 into contact with the hydrodynamic fluids at progressively lower temperatures Ti-5 to Ti8.

The embossing operation on the outer surface of the sheet 10 of thermoplastic laminate 1 at the at least one superficial thermoplastic layer 11 is provided when a combined thermoplastic multilayer 11+12, which was coupled to the at least one superficial thermoplastic layer 11 in a previous cycle of the multiplicity of cycles, is coupled again in a last cycle of the multiplicity of cycles to another first or second layer 21, 22.

The manufacturing method acts to obtain the sheet 10 of thermoplastic laminate 1 univocally without the use of glue between one layer 21 and the other 22 of the multiplicity of thermoplastic layers 11 to 18.

A mounting procedure is used to mount the sheet 10 of thermoplastic laminate 1 to a surface of a piece of furniture or a structure made of wood or particleboard materials, as, for example, medium density fiberboards, so-called MDF. The mounting procedure includes gluing the sheets 10 of thermoplastic laminate 1 onto the surface with the same methods used for the HPL sheets. Alternatively, the mounting of sheets 10 of thermoplastic laminate 1 includes heating a basic surface of the sheet 10 of thermoplastic laminate 1 and pressing the sheet 10 of thermoplastic laminate 1 directly on the surface, so as to reduce the use of glues drastically and advantageously. The sheets 10 of thermoplastic laminate 1 can be advantageously applied to surfaces of pieces of furniture or structures made of wood or particleboard materials thus facing such surfaces.

A piece of furniture or a structure made of wood or particleboard materials that mounts such sheets 10 of thermoplastic laminate 1 to the surfaces thereof are advantageously more shock-resistant and the surface is flatter. The piece of furniture or the structure mounting the sheet 10 of thermoplastic laminate 1 to at least one surface advantageously has higher resistance to stress and to shocks comparable to that of HPL decorative laminated product sheets, the surface of the piece of furniture or of the structure achieves flatness properties that are comparable to those of the HPL sheets. The piece of furniture or structure is assembled using much less glue. The surface of the piece of furniture or of the structure is not subject to deformation and does not have edges that bend upwards on the corners. Advantageously, mounting the sheets 10 of thermoplastic laminate 1 is advantageously easy, the edges of these surfaces do not crack, there are no humidity-related problems and there are no problems of application to the surfaces in humid environments, which has uniform color on the entire thickness of the sheet 10.

The structure made of wood or particleboard materials comprises at least one surface that mounts the sheet 10 made of thermoplastic laminate 1. The sheet 10 of thermoplastic laminate 1 mounted to the surface is manufactured according to the manufacturing method, exemplary embodiments of which are described herein.

The sheet 10 of thermoplastic laminate 1 is mounted to the surface of the piece of furniture or structure made of wood or particleboard materials by pressing or gluing.

Alternatively, a TNT or fiberglass film can be mounted to the back of the sheet 10 of thermoplastic laminate 1 to advantageously increase the mechanical properties, in particular, the technical properties related to flexural modulus.

Again alternatively, the TNT or fiberglass film can be provided between one combined multilayer and the other to advantageously increase some mechanical properties.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the systems, apparatuses, and methods. However, the systems, apparatuses, and methods should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the systems, apparatuses, and methods as defined by the following claims.

What is claimed is:

1. A method for manufacturing a flat laminate sheet, which comprises:
coupling first and second thermoplastic layers to one another without glue by superficially heating coupling surfaces of the first and second thermoplastic layers and pressing the heated first and second thermoplastic layers onto one another without glue to form a first combined thermoplastic multilayer free from glue, the first and second thermoplastic layers each being a film free of plasticizers and comprising at least one of PVC, PET, PETG, PP, and PE; and
coupling a third thermoplastic layer of a film comprising at least one of PVC, PET, PETG, PP, and PE to the first combined thermoplastic multilayer by superficially heating coupling surfaces of the third thermoplastic layer and the first combined thermoplastic multilayer and pressing the heated third thermoplastic layer and the first combined thermoplastic multilayer onto one another without glue to form a multilayer laminate sheet:
free from glue;
being planar, flat, and rigid; and
having a thickness from between approximately 0.75 mm to approximately 4 mm.

2. The method according to claim 1, wherein one of the first, second, or third thermoplastic layers is a superficial thermoplastic layer.

3. The method according to claim 2, wherein the superficial thermoplastic layer is a transparent, crystal superficial thermoplastic layer treated with a finishing paint and having a plasticization between approximately 10 phr to approximately 30 phr.

4. The method according to claim 3, wherein the crystal superficial thermoplastic layer is filled with mineral filers comprising at least one of TiO₂, calcium carbonate, silica, and talc.

5. The method according to claim 2, wherein:
the superficial thermoplastic layer is transparent and has a thickness of approximately 100 micrometers;
each of the ones of the first, second, and third thermoplastic layers has a thickness of approximately 350 micrometers; and
the multilayer laminate sheet has a thickness of approximately 800 micrometers.

6. The method according to claim 1, which further comprises manufacturing each of the first, second, and third thermoplastic layers by calendering and extruding.

7. The method according to claim 1, applying the multilayer laminate sheet by pressing or gluing to a surface of one of a piece of furniture, a wood structures, and particleboard.

8. The method according to claim 1, which further comprises:
before coupling the third thermoplastic layer to the first combined thermoplastic multilayer:
coupling a fourth thermoplastic layer to the third thermoplastic layer without glue by superficially heating coupling surfaces of the third and fourth thermoplastic layers and pressing the heated third and fourth thermoplastic layers onto one another without glue to form a second combined thermoplastic multilayer free from glue, the fourth thermoplastic layer being a film free of plasticizers and comprising at least one of PVC, PET, PETG, PP, and PE;
coupling fifth and sixth thermoplastic layers to one another without glue by superficially heating coupling surfaces of the fifth and sixth thermoplastic layers and pressing the heated fifth and sixth thermoplastic layers onto one another without glue to form a third combined thermoplastic multilayer free from glue, the fifth and sixth thermoplastic layers each being a film free of plasticizers and comprising at least one of PVC, PET, PETG, PP, and PE; and
coupling the second combined thermoplastic multilayer and the third combined thermoplastic multilayer to one another without glue by superficially heating coupling surfaces of the second and third combined thermoplastic multilayers and pressing the heated second and third combined thermoplastic multilayers onto one another without glue to form a fourth combined thermoplastic multilayer free from glue; and
coupling the first combined thermoplastic multilayer and the fourth combined thermoplastic multilayer to one another without glue by superficially heating coupling surfaces of the first and fourth combined thermoplastic multilayers and pressing the heated second and fourth combined thermoplastic multilayers onto one another without glue to form the multilayer laminate sheet.

9. The method according to claim 8, wherein:
an upper layer of the first combined thermoplastic multilayer is a transparent superficial layer approximately 100 micrometers thick;
each of the second, third, fourth, fifth, and sixth thermoplastic layers is approximately 350 micrometers thick; and
the multilayer laminate sheet is approximately 1850 micrometers thick.

10. The method according to claim 1, which further comprises:
before coupling the third thermoplastic layer to the first combined thermoplastic multilayer:
coupling a fourth thermoplastic layer to the third thermoplastic layer without glue by superficially heating coupling surfaces of the third and fourth thermoplastic layers and pressing the heated third and fourth thermoplastic layers onto one another without glue to form a second combined thermoplastic multilayer free from glue, the fourth thermoplastic layer being a film free of plasticizers and comprising at least one of PVC, PET, PETG, PP, and PE;
coupling fifth and sixth thermoplastic layers to one another without glue by superficially heating coupling surfaces of the fifth and sixth thermoplastic layers and pressing the heated fifth and sixth thermoplastic layers onto one another without glue to form a third combined thermoplastic multilayer free from glue, the fifth and sixth thermoplastic layers each being a film free of plasticizers and comprising at least one of PVC, PET, PETG, PP, and PE;
coupling seventh and eighth thermoplastic layers to one another without glue by superficially heating coupling surfaces of the seventh and eighth thermoplastic layers and pressing the heated seventh and eighth thermoplastic layers onto one another without glue to form a fourth combined thermoplastic multilayer free from glue, the seventh and eighth thermoplastic layers each being a film free of plasticizers and comprising at least one of PVC, PET, PETG, PP, and PE;
coupling the second combined thermoplastic multilayer and the third combined thermoplastic multilayer to one another without glue by superficially heating coupling surfaces of the second and third combined thermoplastic multilayers and pressing the heated second and third combined thermoplastic multilayers onto one another without glue to form a fifth combined thermoplastic multilayer free from glue; and
coupling the fourth combined thermoplastic multilayer and the fifth combined thermoplastic multilayer to one another without glue by superficially heating coupling surfaces of the fourth and fifth combined thermoplastic multilayers and pressing the heated fourth and fifth combined thermoplastic multilayers onto one another without glue to form a sixth combined thermoplastic multilayer free from glue; and
coupling the first combined thermoplastic multilayer and the sixth combined thermoplastic multilayer to one another without glue by superficially heating coupling surfaces of the first and sixth combined thermoplastic multilayers and pressing the heated first and sixth combined thermoplastic multilayers onto one another without glue to form the multilayer laminate sheet.

11. The method according to claim 10, wherein:
an upper layer of the first combined thermoplastic multilayer is a transparent superficial layer approximately 100 micrometers thick;
each of the second, third, fourth, fifth, sixth, seventh, and eighth thermoplastic layers is approximately 350 micrometers thick; and
the multilayer laminate sheet is approximately 2550 micrometers thick.

12. The method according to claim 1, wherein the multilayer laminate sheet has mechanical shock resistance properties comprising approximately 60 inches for ball impact resistance and approximately 25 to approximately 28 inches for dart impact resistance.

13. The method according to claim 1, wherein the multilayer laminate sheet has flatness properties comprising a flatness test result of +/−3 mm for a sheet having a thickness of 0.8 mm thick +/−0.05 mm.

14. The method according to claim 1, wherein the multilayer laminate sheet has a dimensional stability lower than 0.2% both in a direction of a sheet-manufacturing machine and in a crosswise direction.

15. The method according to claim 1, wherein the multilayer laminate sheet has a surface resistance at greater than approximately 1500 cycles for printed sheets and greater than approximately 4000 cycles for sheets of uniform color.

16. The method according to claim 1, wherein the multilayer laminate sheet has a post-forming radius at room temperature of 8 mm.

17. The method according to claim 1, which further comprises carrying out a machine coupling cycle by:
coupling the first and second thermoplastic layers with a machine having the first thermoplastic layer on a first cylinder as a first layer and the second thermoplastic layer on a second cylinder as a second layer;
tautly feeding the first and second layers onto respective sets of first and second comb rollers of the machine, at least one roller of each of the sets of first and second comb rollers heated to a respective comb roller temperature by a fluid that heats the respective first and second layers as the first and second layers are fed therethrough;
tautly feeding the first and second layers from the comb rollers to coupling rollers downstream of the comb rollers, the coupling rollers pressing together the first and second layers with pressure to form the first combined thermoplastic multilayer, at least one of the coupling rollers heated to a coupling temperature by a fluid that heats the first combined thermoplastic multilayer as the first combined thermoplastic multilayer is fed therethrough;
heating the first combined thermoplastic multilayer adjacent the coupling rollers with a heater to promote coupling of the first and second layers to form the first combined thermoplastic multilayer; and
tautly feeding the first combined thermoplastic multilayer from the coupling rollers to at least one downstream set of cooling rollers, at least one of the cooling rollers cooled to a cooling temperature by a fluid that cools the first combined thermoplastic multilayer as the first combined thermoplastic multilayer is fed therethrough.

18. The method according to claim 17, which further comprises restarting the first combined thermoplastic multilayer as either the first layer or the second layer for further combined coupling with another combined multilayer previously formed by a previous machine coupling cycle after the first combined thermoplastic multilayer has cooled.

19. The method according to claim 17, which further comprises:
supporting the first combined thermoplastic multilayer downstream of the cooling rollers on a flat and planar surface; and
cutting the first combined thermoplastic multilayer into flat and planar sheets with a cutter disposed adjacent the cooling rollers.

20. The method according to claim 1, wherein the multilayer laminate sheet has an outer surface and which further comprises embossing the outer surface to provide a pattern on the outer surface.
